(19) United States
(12) Patent Application Publication
(10) Pub. No.: US 2020/0160149 A1
(43) Pub. Date: May 21, 2020

(54) KNOWLEDGE COMPLETION METHOD AND INFORMATION PROCESSING APPARATUS

(71) Applicant: FUJITSU LIMITED, Kawasaki-shi (JP)

(72) Inventor: Hajime Morita, Kawasaki (JP)

(73) Assignee: FUJITSU LIMITED, Kawasaki-shi (JP)

(21) Appl. No.: 16/673,345

(22) Filed: Nov. 4, 2019

(30) Foreign Application Priority Data
Nov. 16, 2018 (JP) 2018-215337

(51) Int. Cl. G06N 3/04; G06N 3/08; G06N 5/02

(52) U.S. Cl. CPC G06N 3/0427; G06N 5/02; G06N 3/0454; G06N 3/08

(57) ABSTRACT

A non-transitory computer-readable recording medium has stored therein a program that causes a computer to execute a process including: inputting a first vector value and a second vector value to a first learning model to obtain a first output result, the first vector value corresponding to a subject of text data in which a first relationship between the subject and an object is missing, the second vector value corresponding to mask data generated from the text data by masking the subject and the object; inputting a third vector value and the first vector value to a second learning model to obtain a second output result, the third vector value corresponding to a second relationship to be compensated for the text data; and determining, by using the object, the first output result, and the second output result, whether it is possible for the second relationship to compensate for the text data.

### CROSS-REFERENCE TO RELATED APPLICATION

This application is based upon and claims the benefit of priority of the prior Japanese Patent Application No. 2018-215337, filed on Nov. 16, 2018, the entire contents of which are incorporated herein by reference.

### FIELD

The embodiments discussed herein are related to a knowledge completion method and an information processing apparatus.

### BACKGROUND

Knowledge graphs, which are used for machine learning and so on, are manually generated on a large scale; however, in some of the knowledge graphs, a relationship between elements is missing. As a method of compensation for a missing relationship, distant supervision is known, in which, when there are triplets (subject, relationship, and object) in a knowledge graph, sentences including a pair of the same subject and the same object are learned as sentences representing the relationship and the learned sentences are used to compensate for the relationship. For example, text including a subject and an object is selected to train a recurrent neural network (RNN) that outputs a vector representing a relationship from text. Then, each piece of information of a knowledge graph in which a relationship is missing is input to the trained RNN, and the output information is estimated as the missing information.

Related techniques are disclosed in, for example, Japanese Laid-open Patent Publication No. 2017-76403 and International Publication Pamphlet No. WO 2016/028446.

However, with the techniques mentioned above, text selected in learning through distant supervision includes text in which there is no relationship between the subject and the object, and therefore a wrong relationship may be learned. In such a case, a wrong relationship is estimated for a knowledge graph with a missing relationship. This causes noise in performing learning, decreasing the learning accuracy.

### SUMMARY

According to an aspect of the embodiments, a non-transitory computer-readable recording medium has stored therein a program that causes a computer to execute a process, the process including: inputting a first vector value and a second vector value to a first learning model of estimating an object from a subject to obtain a first output result, the first vector value corresponding to a first subject of text data in which a first relationship between the first subject and a first object of the text data is missing, the second vector value corresponding to mask data generated from the text data by masking the first subject and the first object; inputting a third vector value and the first vector value to a second learning model of estimating an object from a relationship to obtain a second output result, the third vector value corresponding to a second relationship to be compensated for the text data; and determining, by using the first object, the first output result, and the second output result, whether it is possible for the second relationship to compensate for the text data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of a knowledge completion apparatus according to a first embodiment;

FIG. 2 is a diagram illustrating an example of a knowledge graph in which a relationship is missing;

FIG. 3 is a diagram illustrating a text learning process;

FIG. 4 is a diagram illustrating a relationship learning process;

FIG. 5 is a diagram illustrating a relationship estimation process;

FIG. 6 is a flowchart illustrating a flow of a text learning process;

FIG. 7 is a flowchart illustrating a flow of a relationship learning process;

FIG. 8 is a flowchart illustrating a flow of a relationship estimation process;

FIG. 9 is a diagram illustrating neural networks; and

FIG. 10 is a diagram illustrating an example of a hardware configuration.

### DESCRIPTION OF EMBODIMENTS

Hereinafter, embodiments of the present disclosure will be described in detail with reference to the accompanying drawings. The present disclosure is not limited by the embodiments. The embodiments may be appropriately combined to the extent not inconsistent with each other.

### First Embodiment

[Functional Configuration]

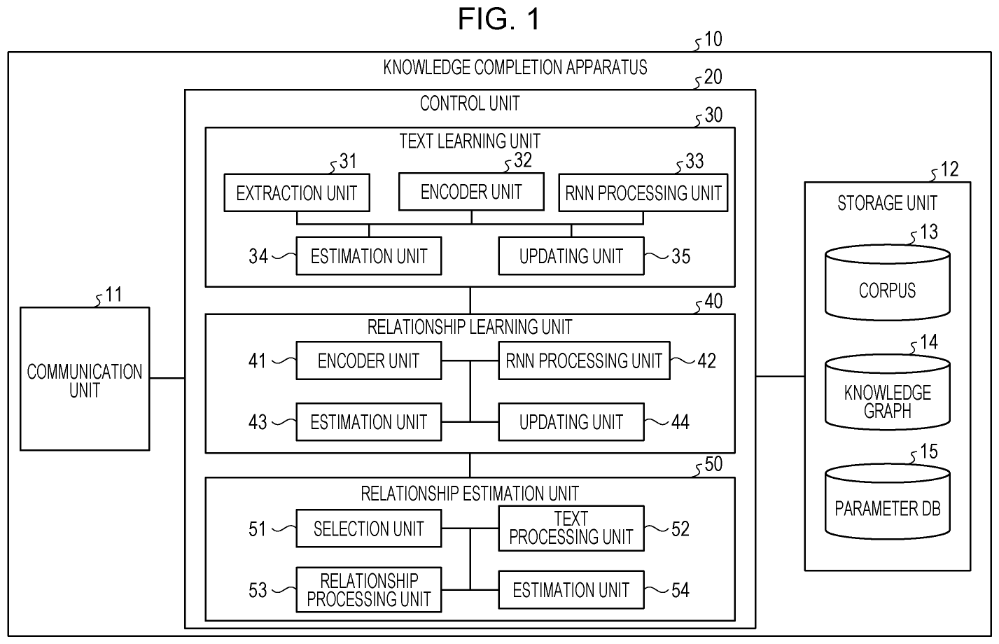

FIG. 1 is a diagram illustrating a functional configuration of a knowledge completion apparatus 10 according to a first embodiment. The knowledge completion apparatus 10 illustrated in FIG. 1 is an example of a computer device that, when the relationship (relation) between elements of a knowledge graph used for machine learning or the like is missing, estimates the relationship and uses the estimated relationship to compensate for the missing relationship. For example, the knowledge completion apparatus 10 generates a unified learning framework for text and a relationship (column) and learns encoding of text and a relationship (column) as a model of estimating the object of a triplet from the subject of the triplet. By using a difference between the results of estimation with text and estimation with a relationship (column), the knowledge completion apparatus 10 determines whether there is a specific relationship.

For example, the knowledge completion apparatus 10 compensates for a lack of a triplet (subject, relationship, and object) in an existing knowledge graph, by performing link prediction with text. The knowledge completion apparatus 10 learns encoding of text to be used for link prediction, as a model of estimating the object of a triplet from the subject of the triplet. In this way, the knowledge completion apparatus 10 may improve the accuracy in estimation of a missing relationship.

As illustrated in FIG. 1, the knowledge completion apparatus 10 includes a communication unit 11, a storage unit 12, and a control unit 20. The communication unit 11 is a processing unit that controls communication with another device and is, for example, a communication interface. For example, the communication unit 11 receives various types of data from a database server or the like and receives various instructions from an administrator terminal or the like.

The storage unit 12 is an example of a storage device storing data and a program that is executed by the control unit 20. The storage unit 12 is, for example, a memory, a hard disk, or the like. The storage unit 12 stores a corpus 13, a knowledge graph 14, and a parameter database (DB) 15.

The corpus 13 is an example of a database storing text data to be learned. For example, the corpus 13 is composed of a plurality of sentences, such as a sentence “ZZZ is president of U.S.”

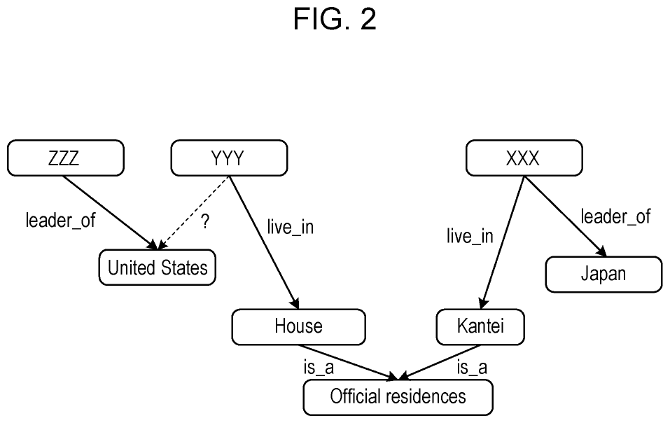

The knowledge graph 14 is an example of a database storing text data that is to be learned and in which the relationship between elements is defined. Text data in which the relationship between elements is missing is included in the knowledge graph 14. FIG. 2 is a diagram illustrating an example of a knowledge graph in which a relationship is missing. The knowledge graph illustrated in FIG. 2 indicates that the relationship between XXX and Japan is “leader_of”, the relationship between XXX and Kantei is “live_in”, and the relationship between Kantei and Official residences is “is_a”. The relationship between YYY and House is “live_in” and the relationship between House and Official residences is “is_a”. The relationship between ZZZ and United States is “leader_of”. In this example, the relationship between YYY and United States is missing.

The parameter DB 15 is a database storing learning results. For example, the parameter DB 15 stores results (classification results) of determination of learning data made by the control unit 20, and various parameters learned by machine learning or the like.

The control unit 20 is a processing unit responsible for the entire knowledge completion apparatus 10 and is, for example, a processor or the like. The control unit 20 includes a text learning unit 30, a relationship learning unit 40, and a relationship estimation unit 50. The text learning unit 30, the relationship learning unit 40, and the relationship estimation unit 50 are examples of electronic circuits included in a processor or examples of processes executed by the processor.

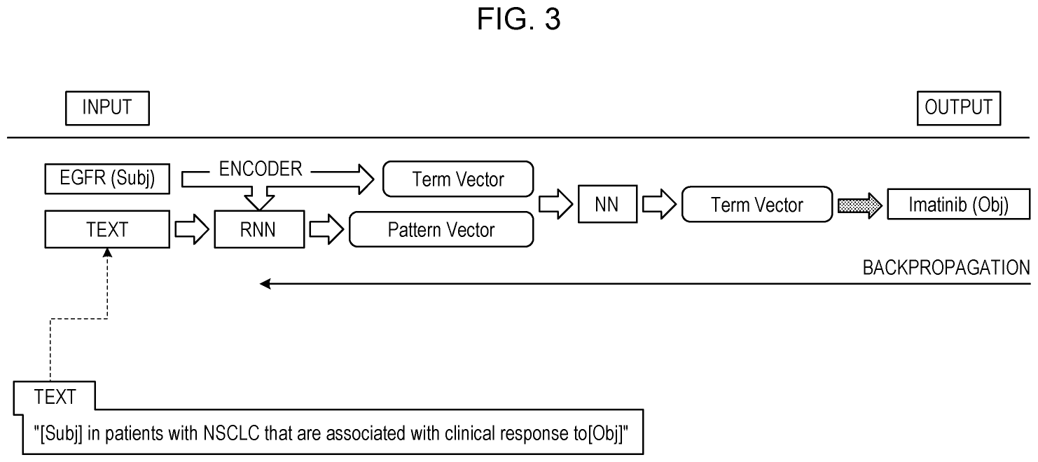

The text learning unit 30 is a processing unit that learns a model of estimating an object from a subject to build a learning model, and includes an extraction unit 31, an encoder unit 32, an RNN processing unit 33, an estimation unit 34, and an updating unit 35. FIG. 3 is a diagram illustrating a text learning process. As illustrated in FIG. 3, by using text data, the text learning unit 30 generates masked text data in which known subject and object are masked. The text learning unit 30 inputs the masked text data to a recurrent neural network (RNN) to obtain a value of a pattern vector.

The text learning unit 30 also inputs “EGFR”, which is a known subject, to an encoder to obtain a value of a subject vector (term vector). The encoder is a neural network (NN) that performs conversion between a word and a vector, a conversion table in which a word and a vector are associated with each other, or the like. In the present embodiment, a value of a vector may be simply referred to as a vector, and a value of a pattern vector may be simply referred to as a pattern vector.

The text learning unit 30 inputs a pattern vector and a subject vector to an NN to obtain an object vector (term vector), which is an output result. Subsequently, the text learning unit 30 compares the obtained object vector with an object vector corresponding to a known object, and updates various parameters possessed by each of the encoder, the RNN, and the NN by backpropagation or the like so as to minimize an error between both the object vectors. In this way, the text learning unit 30 performs a learning process to build a learning model of estimating an object from a subject.

The extraction unit 31 is a processing unit that extracts text data from the corpus 13. For example, the extraction unit 31 extracts text data from the corpus 13 and extracts a subject and an object from the extracted text data by using a dictionary defining a list of subjects and objects. The extraction unit 31 outputs the extracted subject to the estimation unit 34 and outputs the extracted object and an object vector corresponding to the object to the updating unit 35. The extraction unit 31 notifies the RNN processing unit 33 of information on the extracted text data, subject, and object.

The encoder unit 32 is a processing unit that performs an encoder process, which, for example, converts data into another data in accordance with a predetermined rule, to generate a subject vector which is a vector value converted from the subject. For example, the encoder unit 32 uses an encoder to convert a subject input from the extraction unit 31 into a subject vector. The encoder unit 32 outputs the obtained subject vector to the RNN processing unit 33, the estimation unit 34, and the like.

The RNN processing unit 33 is a processing unit that generates a pattern vector from masked text data by using an RNN. For example, the RNN processing unit 33 obtains information on text, a subject, and an object from the extraction unit 31 and generates, from text data with the known subject and object, masked text data in which the subject is masked with [Subj] and the object is masked with [Obj]. The RNN processing unit 33 inputs the subject vector obtained from the encoder unit 32 and the masked text data to the RNN to obtain a pattern vector. The RNN processing unit 33 then outputs the pattern vector to the estimation unit 34.

The estimation unit 34 is a processing unit that estimates an object vector by using an NN. For example, the estimation unit 34 obtains from the encoder unit 32 a subject vector corresponding to a subject that is known in text data. The estimation unit 34 obtains, from the RNN processing unit 33, a pattern vector corresponding to masked text data. The estimation unit 34 inputs the subject vector and the pattern vector to an NN to obtain an object vector as an output result from the NN. The estimation unit 34 then outputs the object vector estimated by using the NN to the updating unit 35.

The updating unit 35 is a processing unit that trains the encoder of the encoder unit 32, the RNN of the RNN processing unit 33, and the NN of the estimation unit 34 based on an estimation result of the estimation unit 34. For example, the updating unit 35 calculates an error between an object vector corresponding to a known object extracted by the extraction unit 31 and an object vector estimated by the estimation unit 34, and updates various parameters possessed by each of the encoder, the RNN, and the NN by backpropagation or the like so as to minimize an error between both the object vectors.

In this way, the text learning unit 30 learns the functions for estimating an object from a subject. The timing of terminating the learning may be set at any time, such as a time at which learning using a predetermined number or more of pieces of learning data is completed, a time at which learning of all pieces of the text data included in the corpus 13 finishes, or a time at which a restoration error reaches less than a predetermined threshold. Upon completion of learning, the text learning unit 30 stores the learned parameters of each of the encoder, the RNN, and the NN in the parameter DB 15.

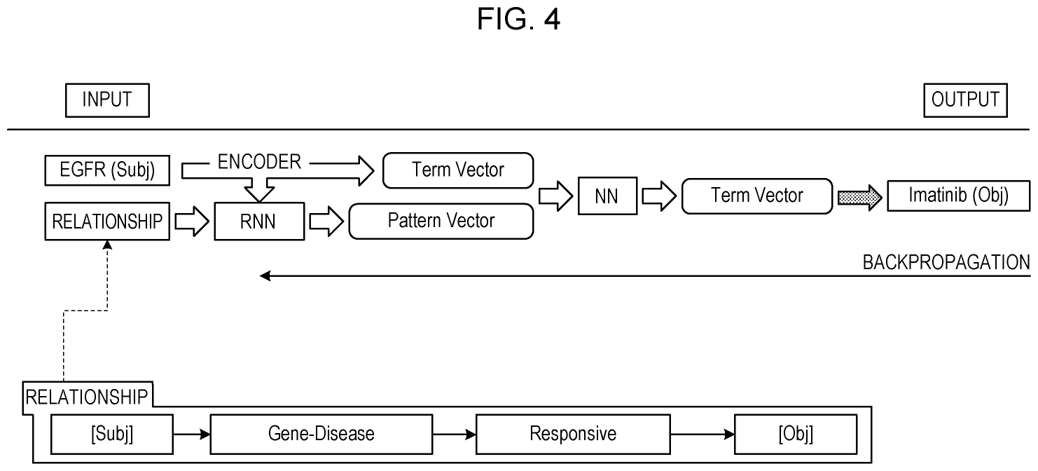

The relationship learning unit 40 is a processing unit that learns a model of estimating an object from a relationship (relation) between a subject and an object to build a learning model, and includes an encoder unit 41, an RNN processing unit 42, an estimation unit 43, and an updating unit 44. FIG. 4 is a diagram illustrating a relationship learning process. As illustrated in FIG. 4, the relationship learning unit 40 inputs to an RNN a known relationship of text data to obtain a pattern vector corresponding to the known relationship.

The relationship learning unit 40 also inputs a known subject “EGFR” to an encoder to obtain a subject vector. The encoder used here, as in the text learning unit 30, is a neural network, a conversion table, or the like that performs conversion between a word and a vector.

The relationship learning unit 40 inputs the pattern vector and the subject vector to an NN to obtain an object vector as an output result from the NN. Subsequently, the relationship learning unit 40 compares the obtained object vector with an object vector corresponding to a known object, and updates various parameters possessed by each of the encoder, the RNN, and the NN by backpropagation or the like so as to minimize an error between both the object vectors. In this way, the relationship learning unit 40 performs a learning process to build a learning model of estimating an object from a relationship.

The encoder unit 41 is a processing unit that performs an encoder process to generate a subject vector which is a vector value converted from the subject. For example, the encoder unit 41 identifies, from the knowledge graph 14, text data in which the relationship is known, and identifies the subject and the object of the text data. The encoder unit 41 uses an encoder to convert the identified subject into a subject vector. The encoder unit 41 then outputs the obtained subject vector, information on the identified relationship, subject, and object, and the like to the RNN processing unit 42, the estimation unit 43, and so on.

The RNN processing unit 42 is a processing unit that generates a pattern vector from a known relationship (relation) by using an RNN. For example, the RNN processing unit 42 obtains the text data in which the relationship is known and which is identified by the encoder unit 41. The RNN processing unit 42 inputs the relationship and the subject vector obtained from the encoder unit 41 to the RNN to obtain a pattern vector that is an output result of the RNN and corresponds to the relationship. The RNN processing unit 42 then outputs the pattern vector to the estimation unit 43.

The estimation unit 43 is a processing unit that estimates an object vector by using an NN. For example, the estimation unit 43 obtains, from the encoder unit 41, a subject vector corresponding to the subject of the text data in which the relationship is known. The estimation unit 43 obtains, from the RNN processing unit 42, a pattern vector corresponding to the known relationship. The estimation unit 43 inputs the obtained subject vector and pattern vector to the NN to obtain an object vector as an output result from the NN. The estimation unit 43 then outputs the object vector to the updating unit 44.

The updating unit 44 is a processing unit that trains the encoder of the encoder unit 41, the RNN of the RNN processing unit 42, and the NN of the estimation unit 43 based on an estimation result of the estimation unit 43. For example, the updating unit 44 calculates an error between an object vector corresponding to a known object of text data identified by the encoder unit 41 and an object vector estimated by the estimation unit 43, and updates various parameters possessed by each of the encoder, the RNN, and the NN by backpropagation or the like so as to minimize the error.

In this way, the relationship learning unit 40 learns the functions for estimating an object from a relationship. The timing of terminating the learning may be set at any time, such as a time at which learning using a predetermined number or more of pieces of learning data is completed, a time at which learning of all pieces of the text data included in the knowledge graph finishes, or a time at which a restoration error reaches less than a predetermined threshold. Upon completion of learning, the relationship learning unit 40 stores the learned parameters of each of the encoder, the RNN, and the NN in the parameter DB 15.

The relationship estimation unit 50 is a processing unit that estimates a missing relationship, and includes a selection unit 51, a text processing unit 52, a relationship processing unit 53, and an estimation unit 54. For example, the relationship estimation unit 50 estimates a missing relationship in estimation-target text data by using a learning model learned by the text learning unit 30 and a learning model learned by the relationship learning unit 40.

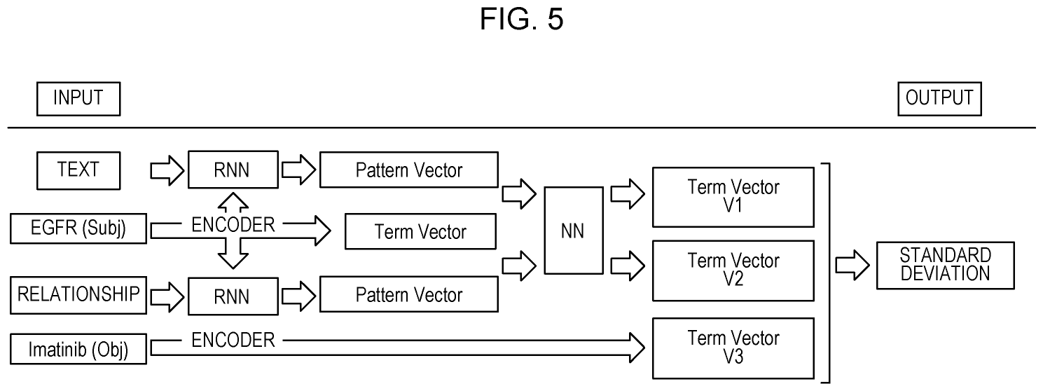

FIG. 5 is a diagram illustrating a relationship estimation process. As illustrated in FIG. 5, the relationship estimation unit 50 inputs, to a learning model learned by the text learning unit 30, masked text data or the like in which the subject and the object of the estimation-target text data, in which the relationship is missing, are masked, and obtains an object vector “Term Vector V1”, which is an estimation result.

The relationship estimation unit 50 assumes that a relationship to be determined is in the estimation-target text data in which the relationship is missing, and inputs the assumed relationship (assumed relation) and the like to a learning model learned by the relationship learning unit 40 to obtain an object vector “Term Vector V2”, which is an estimation result. The relationship estimation unit 50 also obtains, by using an encoder, an object vector “Term Vector V3” from the object of the estimation-target text data in which the relationship is missing.

Based on the object vectors “Term Vector V1”, “Term Vector V2”, and “Term Vector V3”, the relationship estimation unit 50 determines whether the assumed relationship is appropriate. When the assumed relationship is appropriate, the relationship estimation unit 50 provides the relationship to text data; however, when the assumed relationship is not appropriate, the relationship estimation unit 50 assumes another relationship to perform a similar process.

The selection unit 51 is a processing unit that selects estimation-target text data. For example, the selection unit 51 selects from the knowledge graph 14 text data which includes a subject and an object and in which a relationship is missing. The selection unit 51 outputs the selected text data and information about a knowledge graph to the text processing unit 52, the relationship processing unit 53, the estimation unit 54, and so on.

The text processing unit 52 is a processing unit that obtains an object vector “Term Vector V1” from a known subject by using a learning model learned by the text learning unit 30. For example, the text processing unit 52 builds a learned learning model by using parameters stored in the parameter DB 15.

The text processing unit 52 obtains a subject vector corresponding to the subject of the estimation-target text data by using an encoder. The text processing unit 52 generates masked text data in which the subject and the object of the estimation-target text data are masked, and inputs the masked text data and the subject vector to the RNN of the learned learning model to obtain a pattern vector.

The text processing unit 52 inputs the pattern vector and the subject vector to the NN of the learned learning model to obtain the object vector “Term Vector V1”. The text processing unit 52 outputs the obtained object vector “Term Vector V1” to the estimation unit 54.

The relationship processing unit 53 is a processing unit that obtains the object vector “Term Vector V2” from the relationship by using a learning model learned by the relationship learning unit 40. For example, the relationship processing unit 53 builds a learned learning model by using parameters stored in the parameter DB 15.

The relationship processing unit 53 obtains a subject vector corresponding to the subject of the estimation-target text data by using an encoder. The relationship processing unit 53 inputs the subject vector and the assumed relationship to the RNN of the learned learning model to obtain a pattern vector.

The relationship processing unit 53 then inputs the pattern vector and the subject vector to the NN of the learned learning model to obtain the object vector “Term Vector V2”. The relationship processing unit 53 outputs the obtained object vector “Term Vector V2” to the estimation unit 54.

The estimation unit 54 is a processing unit that estimates, by using results of the text processing unit 52 and the relationship processing unit 53, whether the assumed relationship is appropriate. For example, the estimation unit 54 obtains the object vector “Term Vector V1” from the text processing unit 52 and obtains the object vector “Term Vector V2” from the relationship processing unit 53. The estimation unit 54 obtains, by using the learned encoder, the object vector “Term Vector V3” corresponding to the object of the estimation-target text data.

The estimation unit 54 calculates a standard deviation of the object vectors “Term Vector V1”, “Term Vector V2”, and “Term Vector V3” by equation (1). When the standard deviation is less than a predetermined threshold, the estimation unit 54 estimates that the assumed relationship is an appropriate relationship and provides the relationship to a missing portion of the knowledge graph in which the relationship is missing. In contrast, when the standard deviation is greater than or equal to the predetermined threshold, the estimation unit 54 estimates that the assumed relationship is not appropriate. In this case, the estimation unit 54 assumes another relationship to perform a similar process.

$$D = \sqrt{\frac{1}{3} {\sum }_{i = 1}^{3} {( \frac{{V}_{1} + {V}_{2} + {V}_{3}}{3} - {V}_{i} )}^{2}} \qquad ( 1 )$$

[Flow of Processes]

The flow of each process of text learning, relationship learning, and relationship estimation will be described next. The flowchart of each process will be described first and then description will be given of a specific example.

(Flow of Text Learning Process)

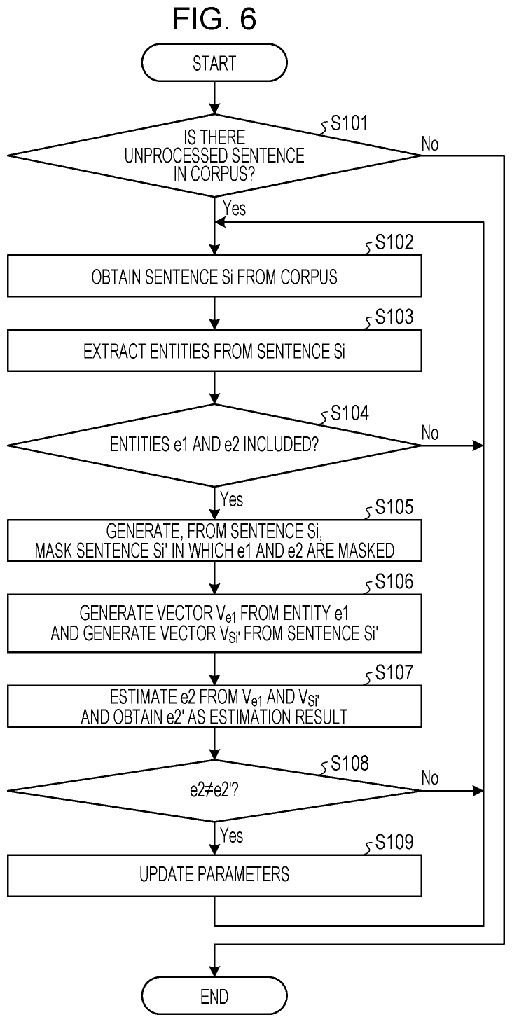

FIG. 6 is a flowchart illustrating the flow of the text learning process. As illustrated in FIG. 6, the text learning unit 30 determines whether there is an unprocessed sentence (text data) in the corpus 13 (S101).

Subsequently, when there is an unprocessed sentence in the corpus 13 (Yes in S101), the text learning unit 30 obtains a sentence Si from the corpus 13 (S102). The text learning unit 30 then extracts entities, such as a subject, an object, a predicate, and a positional particle, from the sentence Si by using a dictionary that is prepared in advance and defines subjects and objects (S103).

Subsequently, the text learning unit 30 determines whether a subject entity e1 and an object entity e2 are included in the sentence Si (S104). When the subject entity e1 and the object entity e2 are included in the sentence Si (Yes in S104), the text learning unit 30 generates, from the sentence Si, a mask sentence Si′ in which the subject entity e1 and the object entity e2 are masked (S105).

Then, the text learning unit 30 generates a subject vector Vₑ₁ from the subject entity e1 by using an encoder, and generates a pattern vector V_{si′} by inputting the subject vector Vₑ₁ and the mask sentence Si′ to an RNN (S106). The text learning unit 30 inputs the subject vector Vₑ₁ and the pattern vector V_{si′} to an NN to estimate the object entity e2, and obtains an estimated object entity e2′ as an estimation result (S107).

When the known object entity e2 differs from the estimated object entity e2′ (Yes in S108), the text learning unit 30 learns parameters of the encoder, the RNN, the NN, and the like so as to minimize an error therebetween (S109). Then, the process returns to S102.

When the known object entity e2 is equal to the estimated object entity e2′ (No in S108) or when a subject entity or an object entity is not included in the sentence Si (No in S104), the process returns to S102. When no sentence remains unprocessed in the corpus 13 (No in S101), the text learning unit 30 terminates the process.

Description will now be given of a specific example. The text learning unit 30 obtains “ZZZ is president of U.S.” as the sentence Si, which is an example of text data, from the corpus 13. The text learning unit 30 performs morphological analysis or the like of the sentence Si to extract “ZZZ” as the subject entity e1 and “U.S.” as the object entity e2.

Subsequently, the text learning unit 30 generates a mask sentence Si′ “[Subj] is president of [Obj]” in which the subject entity e1 and the object entity e2 of the sentence Si are masked. The text learning unit 30 then generates a subject vector Vₑ₁[0, 0.8, 0.5, 1, 15, −0.6, . . . ] from “ZZZ”, which is the subject entity e1, by using an encoder. The text learning unit 30 inputs the subject vector Vₑ₁[0, 0.8, 0.5, 1, 15, −0.6, . . . ] and the mask sentence Si′ to the RNN to generate a pattern vector V_{Si′}[0, 1, −0.6, 15, 0.8, 0.5, . . . ].

The text learning unit 30 inputs the subject vector Vₑ₁[0, 0.8, 0.5, 1, 15, −0.6, . . . ] and the pattern vector V_{Si′}[0, 1, −0.6, 15, 0.8, 0.5, . . . ] to the NN to estimate vector data of the estimated object entity e2′, which is an estimation result of the object entity e2.

The text learning unit 30 then performs learning so as to minimize the error between the estimated object entity e2′, which results from estimation, and “U.S.”, which is the known object entity e2. For example, the text learning unit 30 calculates an error between a vector value corresponding to the estimated object entity e2′ and a vector value corresponding to “U.S.”, which is the known object entity e2, and performs learning by backpropagation so as to minimize the error.

(Flow of Relationship Learning Process)

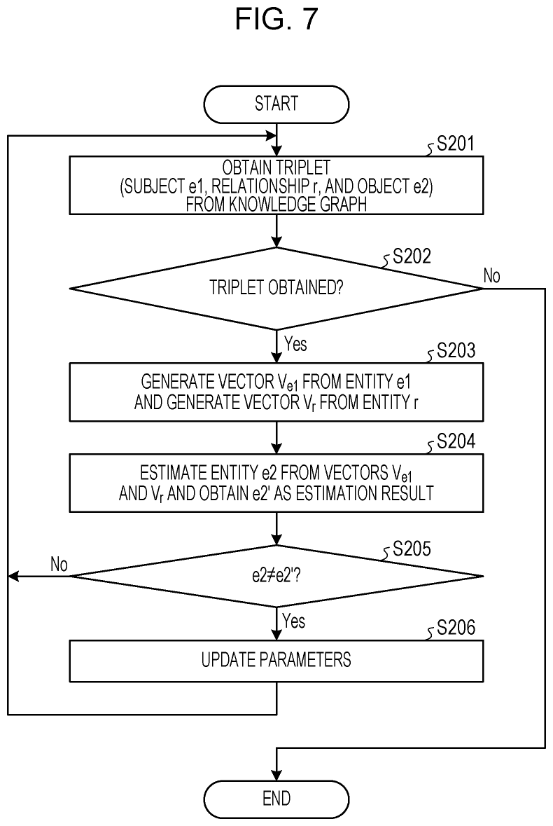

FIG. 7 is a flowchart illustrating the flow of the relationship learning process. As illustrated in FIG. 7, the relationship learning unit 40 obtains a triplet (subject entity e1, relationship entity r, and object entity e2) from a knowledge graph (S201). When the relationship learning unit 40 is unable to obtain the triplet from the knowledge graph (No in S202), the relationship learning unit 40 terminates the process.

When the relationship learning unit 40 has been able to obtain the triplet from the knowledge graph (Yes in S202), the relationship learning unit 40 generates the subject vector Vₑ₁ from the subject entity e1 by using an encoder and inputs the subject vector Vₑ₁ and the relationship entity r to the RNN to generate a pattern vector Vᵣ (S203). The relationship learning unit 40 inputs the subject vector Vₑ₁ and the pattern vector Vᵣ to the NN to estimate the object entity e2, and obtains an estimated object entity e2′ as an estimation result (S204).

When the known object entity e2 differs from the estimated object entity e2′ (Yes in S205), the relationship learning unit 40 learns parameters of the encoder, the RNN, the NN, and the like so as to minimize the error (S206). Then, the process returns to S201. When the known object entity e2 and the estimated object entity e2′ are equal (No in S205), the relationship learning unit 40 does not execute S206, and the process returns to S201.

Description will be given of a specific example of the above. The relationship learning unit 40 obtains “ZZZ” as the subject entity e1, “leader_of” as the relationship entity r, and “U.S.” as the object entity e2 from a knowledge graph.

The relationship learning unit 40 then generates the subject vector Vₑ₁[0, 0.8, 0.5, 1, 15, −0.6, . . . ] from “ZZZ”, which is the subject entity e1, by using an encoder. The relationship learning unit 40 also inputs the subject vector Vₑ₁[0, 0.8, 0.5, 1, 15, −0.6, . . . ] and “leader_of”, which is the relationship entity r, to the RNN to generate a pattern vector Vᵣ[0, 1, −0.6, 15, 0.8, . . . ].

The relationship learning unit 40 then inputs the subject vector Vₑ₁[0, 0.8, 0.5, 1, 15, −0.6, . . . ] and the pattern vector Vᵣ[0, 1, −0.6, 15, 0.8, . . . ] to the NN to estimate vector data of the estimated object entity e2′, which is an estimation result of the object entity e2.

The relationship learning unit 40 then performs learning so as to minimize the error between the estimated object entity e2′, which results from estimation, and “U.S.”, which is the known object entity e2. For example, the relationship learning unit 40 calculates an error between a vector value corresponding to the estimated object entity e2′ and a vector value corresponding to “U.S.”, which is the known object entity e2, and performs learning by backpropagation so as to minimize the error.

(Flow of Relationship Estimation Process)

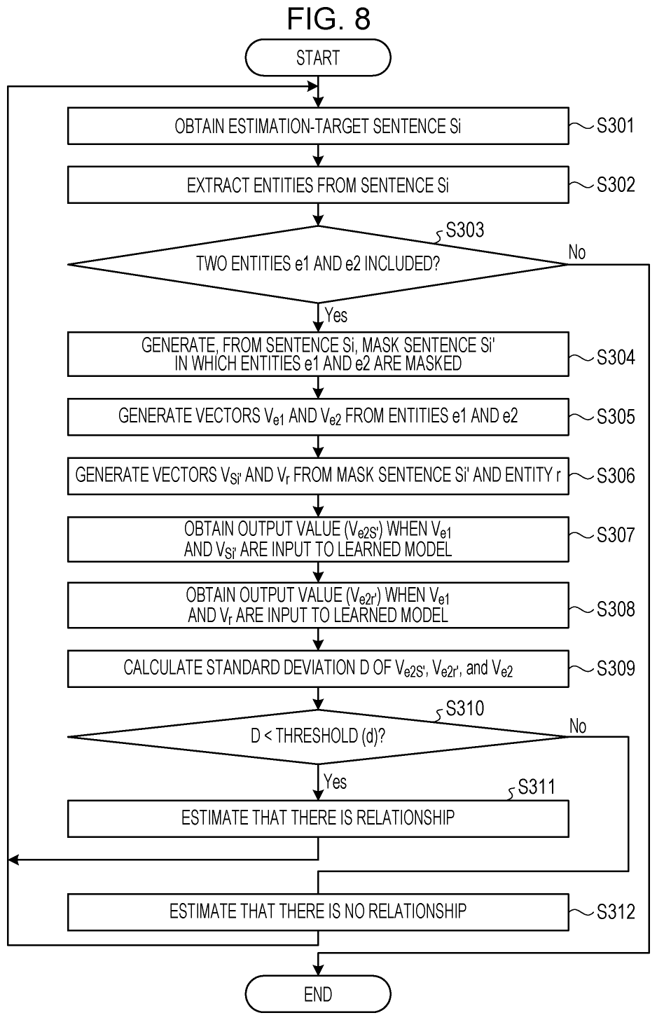

FIG. 8 is a flowchart illustrating the flow of the relationship estimation process. As illustrated in FIG. 8, the relationship estimation unit 50 obtains from the knowledge graph 14 an estimation-target sentence Si in which the relationship is missing (S301).

Subsequently, the relationship estimation unit 50 extracts entities, such as a subject, an object, a predicate, and a positional particle, from the sentence Si by using a dictionary that is prepared in advance and that defines subjects and objects (S302). Subsequently, the relationship estimation unit 50 determines whether a subject entity e1 and an object entity e2 are included in the sentence Si (S303). When a subject entity e1 or an object entity e2 is not included in the sentence Si (No in S303), the relationship estimation unit 50 terminates the process.

When the subject entity e1 and the object entity e2 are included in the sentence Si (Yes in S303), the relationship estimation unit 50 generates, from the sentence Si, a mask sentence Si′ in which the subject entity e1 and the object entity e2 are masked (S304).

The relationship estimation unit 50 generates a subject vector Vₑ₁ from the subject entity e1 and generates an object vector Vₑ₂ from the object entity e2 by using an encoder (S305). The relationship estimation unit 50 inputs the subject vector Vₑ₁ and the mask sentence Si′ to the RNN to generate a pattern vector V_{si′}, and inputs the subject vector Vₑ₁ and the relationship entity r to an RNN to generate a pattern vector Vᵣ (S306).

The relationship estimation unit 50 inputs the subject vector Vₑ₁ and the pattern vector V_{si′} to a learned learning model, which is learned by the text learning unit 30, to obtain an output value V_{e2S′} (S307). The relationship estimation unit 50 inputs the subject vector Vₑ₁ and the pattern vector Vᵣ to a learned learning model, which is learned by the relationship learning unit 40, to obtain an output value V_{e2r′} (S308).

The relationship estimation unit 50 calculates a standard deviation D of the output value V_{e2S′}, the output value V_{e2r′}, and the object vector Vₑ₂ (S309). When the standard deviation D is less than a predetermined threshold (d) (Yes in S310), the relationship estimation unit 50 estimates that the relationship entity r is an appropriate relationship (S311), and the process returns to S301. When the standard deviation D is greater than or equal to the predetermined threshold (d) (No in S310), the relationship estimation unit 50 estimates that the relationship entity r is an inappropriate relationship (S312), and the process returns to S301.

Description will now be given of a specific example. The relationship estimation unit 50 obtains “YYY is president of U.S.” as the sentence Si in which the relationship between the subject and the object is missing. The set relationship entity r is assumed to be “leader_of” and the predetermined threshold d is assumed to be “0.3”.

The relationship estimation unit 50 performs morphological analysis or the like of the sentence Si to extract “YYY” as the subject entity e1 and “U.S.” as the object entity e2. Subsequently, the relationship estimation unit 50 generates a mask sentence Si′ “[Subj] is president of [Obj]” in which the subject entity e1 and the object entity e2 of the sentence Si are masked.

The relationship estimation unit 50 generates, by using an encoder, the subject vector Vₑ₁[0, 0.8, 0.5, 1, 15, −0.6, . . . ] from “YYY”, which is the subject entity e1, and the object vector Vₑ₂[0, 1, 5, 0.8, −0.6, 0.5, . . . ] from “U.S.”, which is the object entity e2.

The relationship estimation unit 50 inputs the subject vector Vₑ₁[0, 0.8, 0.5, 1, 15, −0.6, . . . ] and the mask sentence Si′ to the RNN to generate a pattern vector V_{si′}[0, 1, −0.6, 15, 0.8, 0.5, . . . ]. Similarly, the relationship estimation unit 50 inputs the subject vector Vₑ₁[0, 0.8, 0.5, 1, 15, −0.6, . . . ] and “leader_of”, which is the relationship entity r, to the RNN to generate a pattern vector Vᵣ[0, 1, −0.3, 2, 1.8, −0.2, . . . ].

The relationship estimation unit 50 then inputs the subject vector Vₑ₁[0, 0.8, 0.5, 1, 15, −0.6, . . . ] and the pattern vector V_{Si′}[0, 1, −0.6, 15, 0.8, 0.5, . . . ] to the NN to obtain an output value V_{e2S′}[0, 1, −0.6, 15, 0.8, 0.5, . . . ]. Similarly, the relationship estimation unit 50 inputs the subject vector Vₑ₁[0, 0.8, 0.5, 1, 15, −0.6, . . . ] and the pattern vector Vᵣ[0, 1, −0.3, 2, 18, −0.2, . . . ] to the NN to obtain an output value V_{e2r′}[0, 1, −0.6, 15, 0.8, 0.5, . . . ].

Then, the relationship estimation unit 50 calculates, by using equation (1), the standard deviation D of the output value V_{e2S′}[0, 1, −0.6, 15, 0.8, 0.5, . . . ], the output value V_{e2r′}[0, 1, −0.6, 15, 0.8, 0.5, . . . ], and the object vector Vₑ₂[0, 1, 5, 0.8, −0.6, 0.5, . . . ] as [0.01].

In the case of this example, since the standard deviation D [0.01] is less than the predetermined threshold [0.3], the relationship estimation unit 50 determines that the assumed relationship entity r is appropriate. For example, for the sentence Si “YYY is president of U.S.” in which the relationship is missing, the relationship estimation unit 50 estimates that the relationship between “YYY” and “U.S.” is “leader_of”, which is the relationship entity r, and provides the relationship entity r to the sentence Si.

[Effects]

As described above, the knowledge completion apparatus 10 may avoid being influenced by text including noise and highly accurately perform link prediction using text. For example, in many methods, in the case where text data “ZZZ tweeted about US Post Office.”, which acts as noise, is learned as a relationship representing “leader_of”, when link prediction is performed by using a sentence “AAA tweeted about US Post Office”, the relationship between “AAA” and “US” is incorrectly learned such that the relationship is classified as “leader_of”.

In contrast, assuming that “leader_of” is defined between “AAA” and “Japan” in the knowledge graph, when the knowledge completion apparatus 10 learns the same sentence and performs link prediction with the same sentence, “US” is estimated from “AAA” in the text data learning model and “Japan” is estimated from “AAA” in the relationship learning model, so the influence of text including noise may be avoided.

### Second Embodiment

Although the first embodiment of the present disclosure has been described above, the present disclosure may be implemented in various forms other than the first embodiment.

[Learning Model]

Although, in the first embodiment, description has been given of the example using the RNN, the present disclosure is not limited to this, and other neural networks such as long short-term memory (LSTM) may be used. The vector values described in the above-described examples are merely exemplary and are not intended to limit numerical values and the like.

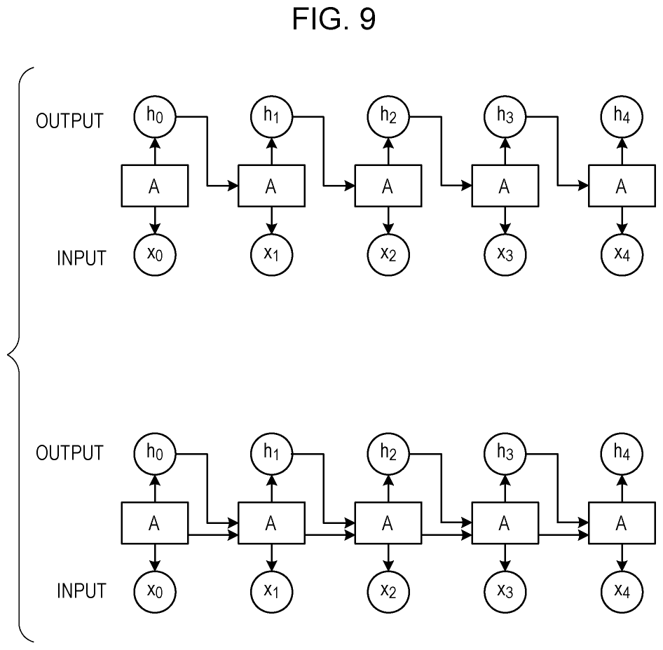

FIG. 9 is a diagram illustrating neural networks. In the upper portion of FIG. 9, an example of an RNN is illustrated; in the lower portion of FIG. 9, an example of an LSTM is illustrated. The RNN illustrated in the upper portion of FIG. 9 is a neural network in which the output of the RNN is received by the RNN itself in the next step. For example, an output value (h₀), which is output by inputting a first input value (x₀) to a first RNN (A), and a second input value (x₁) are input to a second RNN (A). In this way, inputting an output value from an intermediate layer (hidden layer) to the next intermediate layer (hidden layer) enables learning using a variable data size to be performed.

The LSTM illustrated in the lower portion of FIG. 9 is a neural network that has states inside itself in order to learn a long-term dependence between inputs and outputs. For example, an output value (h₀), which is output by inputting a first input value (x₀) to a first LSTM (A), and a feature, which is calculated by the first LSTM (A), are input together with a second input value (x₁) to a second LSTM (A). In this way, by inputting an output value of an intermediate layer (hidden layer) and a feature obtained in the intermediate layer to the next intermediate layer, a memory related to inputs in the past may be maintained.

[Learning Apparatus and Estimation Apparatus]

Although, in the first embodiment, an example in which the knowledge completion apparatus 10 performs learning and estimation has been described, the present disclosure is not limited to this and the learning process and the estimation process may be achieved by different devices. For example, a learning apparatus that performs processing of the text learning unit 30 and the relationship learning unit 40, and an estimation apparatus that performs processing of the relationship estimation unit 50 by using a result of the learning apparatus may be used.

[System]

The aforementioned process procedures, control procedures, specific names, information including various types of data and parameters that are described herein and illustrated in the drawings may be freely changed unless otherwise specified.

The constituent components of the devices illustrated in the drawings are functionally conceptual and not needed to be physically configured as illustrated in the drawings. For example, specific forms of distribution and integration of the devices are not limited to those illustrated in the drawings. That is, all or some of the devices may be functionally or physically distributed or integrated in any units in accordance with various loads, usage statuses, and so on. For example, the text learning unit 30, the relationship learning unit 40, and the relationship estimation unit 50 may be implemented in different housings.

All or any part of the processing functions performed by the devices may be implemented by a central processing unit (CPU) and a program that is executed by the CPU or may be implemented as hardware with wired logic.

[Hardware]

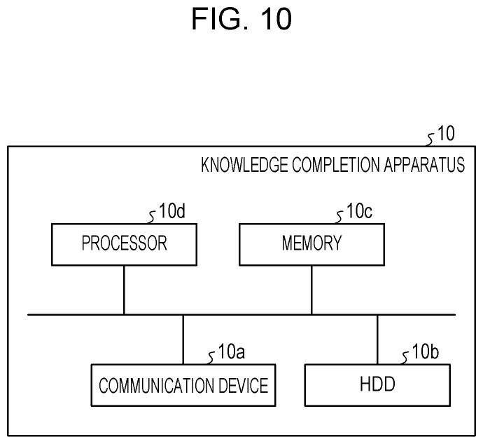

FIG. 10 is a diagram illustrating an example of a hardware configuration. As illustrated in FIG. 10, the knowledge completion apparatus 10 includes a communication device 10a, a hard disk drive (HDD) 10b, a memory 10c, and a processor 10d. The devices illustrated in FIG. 10 are coupled to each other via a bus or the like.

The communication device 10a is a network interface card or the like and performs communication with another server. The HDD 10b stores a program for causing the functions illustrated in FIG. 1 to operate, and a DB.

The processor 10d reads, from the HDD 10b or the like, a program for executing substantially the same processes as those of the processing units illustrated in FIG. 1 and loads the program into the memory 10c, thereby executing a process of performing the functions described with reference to FIG. 1 and so on. For example, this process performs substantially the same functions as the processing units included in the knowledge completion apparatus 10. For example, the processor 10d reads programs having the same functions as those of the text learning unit 30, the relationship learning unit 40, the relationship estimation unit 50, and the like from the HDD 10b and the like. Then, the processor 10d executes processes of executing substantially the same processing as the text learning unit 30, the relationship learning unit 40, the relationship estimation unit 50, and the like.

Thus, the knowledge completion apparatus 10 operates as an information processing apparatus that performs a knowledge completion method by reading and executing a program. The knowledge completion apparatus 10 may implement substantially the same functions as those in the first embodiment by reading the program from a recording medium by using a medium reading device and executing the read program. The program according to the second embodiment is not limited to a program that is executed by the knowledge completion apparatus 10. For example, the disclosure is similarly applicable to the case where another computer or a server executes the program and to the case where the other computer and the server collaborate with each other to execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
inputting a first vector value and a second vector value to a first learning model of estimating an object from a subject to obtain a first output result, the first vector value corresponding to a first subject of text data in which a first relationship between the first subject and a first object of the text data is missing, the second vector value corresponding to mask data generated from the text data by masking the first subject and the first object;
inputting a third vector value and the first vector value to a second learning model of estimating an object from a relationship to obtain a second output result, the third vector value corresponding to a second relationship to be compensated for the text data; and
determining, by using the first object, the first output result, and the second output result, whether it is possible for the second relationship to compensate for the text data.

2. The non-transitory computer-readable recording medium according to claim 1, the process further comprising:
calculating a standard deviation of a fourth vector value corresponding to the first object, a vector value of the first output result, and a vector value of the second output result;
determining, when the standard deviation is less than a predetermined threshold, that it is possible for the second relationship to compensate; and
determining, when the standard deviation is more than or equal to the predetermined threshold, that it is not possible for the second relationship to compensate.

3. The non-transitory computer-readable recording medium according to claim 2, the process further comprising:
providing, when it is determined that it is possible for the second relationship to compensate, the second relationship to the text data in place of the first relationship.

4. The non-transitory computer-readable recording medium according to claim 1, the process further comprising:
learning the first learning model by using first learning data including a subject and an object; and
learning the second learning model by using second learning data which includes a subject and an object and in which a third relationship between the subject and the object of the second learning data is defined.

5. The non-transitory computer-readable recording medium according to claim 4, the process further comprising:
training, as the first learning model, each of an encoder, a first neural network, and a second neural network, the encoder being configured to convert the subject of the first learning data into a fourth vector value, the first neural network being configured to output a pattern vector value by using first mask data and the fourth vector value, the first mask data being generated from the first learning data by masking the subject and the object of the first learning data, the second neural network being configured to output a vector value corresponding to an object by using the fourth vector value and the pattern vector value.

6. The non-transitory computer-readable recording medium according to claim 4, the process further comprising:
training, as the second learning model, each of an encoder, a first neural network, and a second neural network, the encoder being configured to convert the subject of the second learning data into a fourth vector value, the first neural network being configured to output a pattern vector value by using a vector value corresponding to the third relationship and the fourth vector value, the second neural network being configured to output a vector value corresponding to an object by using the fourth vector value and the pattern vector value.

7. The non-transitory computer-readable recording medium according to claim 5, wherein
in each of the first neural network and the second neural network, only a first output of a first intermediate layer is input to a second intermediate layer from the first intermediate layer or the first output and a feature obtained in the first intermediate layer are input to the second intermediate layer from the first intermediate layer.

8. A knowledge completion method, comprising:
inputting, by a computer, a first vector value and a second vector value to a first learning model of estimating an object from a subject to obtain a first output result, the first vector value corresponding to a first subject of text data in which a first relationship between the first subject and a first object of the text data is missing, the second vector value corresponding to mask data generated from the text data by masking the first subject and the first object;
inputting a third vector value and the first vector value to a second learning model of estimating an object from a relationship to obtain a second output result, the third vector value corresponding to a second relationship to be compensated for the text data; and
determining, by using the first object, the first output result, and the second output result, whether it is possible for the second relationship to compensate for the text data.

9. An information processing apparatus, comprising:
a memory; and
a processor coupled to the memory and the processor configured to:
input a first vector value and a second vector value to a first learning model of estimating an object from a subject to obtain a first output result, the first vector value corresponding to a first subject of text data in which a first relationship between the first subject and a first object of the text data is missing, the second vector value corresponding to mask data generated from the text data by masking the first subject and the first object;
input a third vector value and the first vector value to a second learning model of estimating an object from a relationship to obtain a second output result, the third vector value corresponding to a second relationship to be compensated for the text data; and
determine, by using the first object, the first output result, and the second output result, whether it is possible for the second relationship to compensate for the text data.
